(19) United States
(12) Patent Application Publication
(10) Pub. No.: US 2022/0135803 A1
(43) Pub. Date: May 5, 2022

(54) MATERIAL COMPOSITION FOR 3D-PRINTING OF PLANT-BASED FIBERS

(71) Applicant: Christoph Klemmt, Cincinnati, OH (US)

(72) Inventor: Christoph Klemmt, Cincinnati, OH (US)

(21) Appl. No.: 17/511,683

(22) Filed: Oct. 27, 2021

Related U.S. Application Data
(60) Provisional application No. 63/107,059, filed on Oct. 29, 2020.

(51) Int. Cl. C08L 97/02; B33Y 70/10

(52) U.S. Cl. CPC C08L 97/02; C08L 2201/06; B33Y 70/10

(57) ABSTRACT

The present invention is for a material composition based on plant fibers, which can be used for 3D-printing at small as well as large scales. The material composition is biodegradable, it is based on renewable ingredients, and it uses little energy for the material production and extrusion processes. The material composition contains plant fiber, which may be wood chips or cellulose, a binder, which may be starch or methyl cellulose, and a solvent, which may be water. The composition may also contain an acid, which may be vinegar, an additive to control the drying speed, and preservatives to prevent microbial growth. The material composition can be 3D-printed by a robot-controlled extruder, with a width and height of individual layers greater than 10.

### TECHNICAL FIELD

The present embodiments relate to three-dimensional printing, or 3D-printing. More specifically, provided is a sustainable material composition comprising plant fibers for use in applications related to printing 3D objects.

### BACKGROUND

The printing of three-dimensional objects, or 3D-printing, is a method of manufacturing by which layers of material are deposited onto the previous layers, thereby iteratively building up the object to be manufactured. Mostly thermoplastics are used for this process, but various other materials have also been used such as metals, concrete or glass. The material is commonly extruded by an extruder through a nozzle that is controlled and moved by a computer.

Plant-based fibers such as wood products are used in some 3D-printing materials. Small wood particles such as saw dust are used as a filler for thermopolymers such as polylactic acid (PLA). The binding of larger wood particles such as wood chips has been attempted with gypsum, cellulose, sodium silicate and cement. Apart from the binding of the fibers, a problem to be overcome is the build-up and clogging of the fibers within the extrusion mechanism.

### BRIEF SUMMARY

The present invention encompasses a material composition for 3D-printing that can be extruded from a computer-controlled machine. The material is a composite of plant-based fibers and a binder. The present invention recognizes the need for 3D-printing materials to be sustainable by using renewable ingredients, by being biodegradable, and by using minimal amounts of energy in the material production and manufacturing process. The present invention further recognizes the need for 3D-printing materials and their related 3D-printing processes to be able to produce objects at the small as well as the large scale, as in with extrusion bead diameters above 10mm.

The present invention encompasses material compositions that can be extruded at a layer thickness and width larger than 10mm. The invention encompasses material compositions that can be extruded at a low viscosity, with the curing and/or drying of the binder happening after the extrusion.

### BRIEF DESCRIPTION OF THE DRAWINGS

FIG. 1 is the chemical structure of cellulose. Several of the ingredients of the invention are based on glucose units. In cellulose, those are alternatingly rotated by 180 degree.

FIG. 2 is the chemical structure of lignin. In wood, the cellulose fibers are embedded in lignin. In paper pulp, the lignin has been removed from the cellulose.

FIG. 3 is the chemical structure of amylose. With amylopectin it is one of the two main components of starch.

FIG. 4 is the chemical structure of amylopectin. With amylose it is one of the two main components of starch.

FIG. 5 is the chemical structure of agarose. With agaropectin it is one of the two main components of agar.

FIG. 6 is the chemical structure of agaropectin. With agarose it is one of the two main components of agar.

FIG. 7 is a chemical structure of methyl cellulose.

FIG. 8 is prototype that has been 3D-printed with the present invention. The material was prepared according to the specific embodiment of the invention as described under Detailed Description. The prototype was 3D-printed with a custom extruder attached to a robotic arm FIG. 9, FIG. 10.

FIG. 9 is a possible extruder to 3D-print with the proposed material composition, as attached to a robotic arm. The extruder has been used to 3D-print the prototype of FIG. 8.

FIG. 10 is a possible extruder to 3D-print with the proposed material composition. The extruder has been used to 3D-print the prototype of FIG. 8.

### DETAILED DESCRIPTION OF THE INVENTION

3D-printing at the large scale has been developed for a variety of materials such as cementitious materials, thermoplastics, soil, metal and spray foam. Except for soil, most of these materials have negative environmental impacts such as a high consumption of energy, non-renewable resources and materials that do not biodegrade and are not biocompatible. Large-scale 3D-printing of materials based on plant fibers currently only exists where the plant fiber is used as a filler for unsustainable materials such as cement or thermoplastics.

3D-printing of wood materials at the small scale exists as the printing of thermoplastics with wood powder as a filler. The 3D-printing of thermoplastics currently cannot be scaled up beyond a layer width of a few millimeters as the material is melted by heat to be extruded, but after the extrusion the material has to cool down enough to support the subsequent layer before it can be extruded above. At a larger extrusion width it takes more time to cool the material down. At the small scale, various other experimental methods for the 3D-printing of plant fibers have been developed that currently do not exist at a larger scale.

The present invention is a composite material composition that is based on plant-based fibers that are bound by a binder that cures and/or dries fully after the extrusion. The plant fibers, binder, and additives are biodegradable, so that the resulting composite is entirely biodegradable. As the viscous material cures or dries fully after the extrusion, it allows for a 3D-printing at large layer widths. The energy consumption of the process is low as a melting of the material is not required, and the materials do not have a high energy consumption in their production.

The binder and/or additives provide a viscosity of the material that prevents a clogging of the fibers within the extrusion mechanism and ensures the successful delivery of the material out of the nozzle.

An extruder needs to pump the material to deposit it. Various pumps can extrude composite materials that contain larger parts. Therefore, depending on the pumping mechanism of the extruder, the plant fiber can have larger sizes such as wood chips. If the plant fiber is of a larger size and is stiff as in the case of wood chips, it may be necessary to achieve a softening of the fiber to avoid a clogging of the extruder, for example by soaking the material.

The 3D-printing at a large layer width, as in above 10 mm, can lead to a curing or drying of the outer surface of the printed volume that traps moisture on the inside of the printed volume. This is overcome by including an additive in the material composition that slows down the drying process, such as a salt.

The extended drying process when including an additive that increases the drying time, also increases the likeliness of microbial growth and decomposition of the biodegradable material. This is overcome by including a preservative in the material composition.

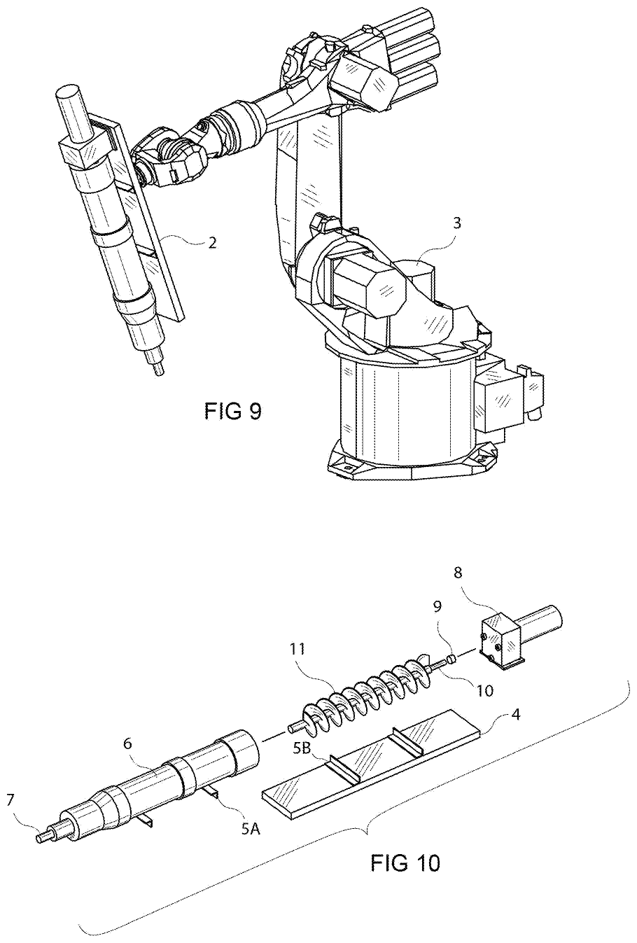

A possible extruder for the 3D-printing of the material is shown in FIG. 9. The extruder is attached to a computer-controlled robot 3 of FIG. 9 (KUKA KR20-3 with controller KR C4). A tool changer 2 of FIG. 9 (Millibar MTC-UR3510) is connected to the robot, which in turn holds the frame 4 of FIG. 10 (Aluminum RHS, 125 mm×50 mm×3 mm) of the extruder. Brackets 5A of FIGS. 10 and 5B of FIG. 10 (Aluminum Angles, 40 mm×40 mm×3 mm) are connecting the frame to PVC pipes 6 of FIG. 10 (PVC pipes: 100 mm×100 mm×50 mm Wye, 100 mm×300 mm clear pipe, 100 mm×50 mm reducer hub, 50 mm×100 mm pipe, 50 mm×40 mm/25 mm reducer hub) that have been glued together and include openings at the top, the bottom and the side. PVC nozzles with different diameters 7 of FIG. 10 (40 mm/25 mm/19 mm diameter) can be screwed onto the end of the PVC pipes. A motor 8 of FIG. 10 (Dayton Model 1Z824 DC Gear Motor 50 RPM ⅙ hp 12 VDC) is attached to the frame. It rotates an auger 11 of FIG. 10 with decreasing diameters (100 mm diameter, 50 mm diameter, 20 mm diameter) to which it is connected via a coupling 9 of FIG. 10 (Lovejoy L099 HUB, keyed flexible shaft coupling 16 mm/19 mm) and a steel rod connector 10 of FIG. 10.

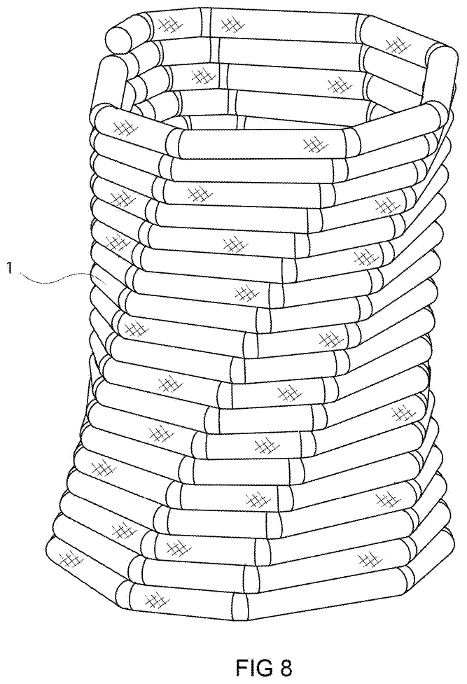

The material is fed into the PVC pipes 6 of FIG. 10 through the opening on the side. When the motor 7 of FIG. 10 is turned on, it rotates the auger 11 of FIG. 3, thereby pressing any material in the main PVC pipe downwards and out of the nozzle 7 of FIG. 10. The robotic arm 3 of FIG. 9 moves the extruder to control the positioning of the material deposition and thereby the shape of the extruded material. An example of an extrusion can be seen in 1 of FIG. 8.

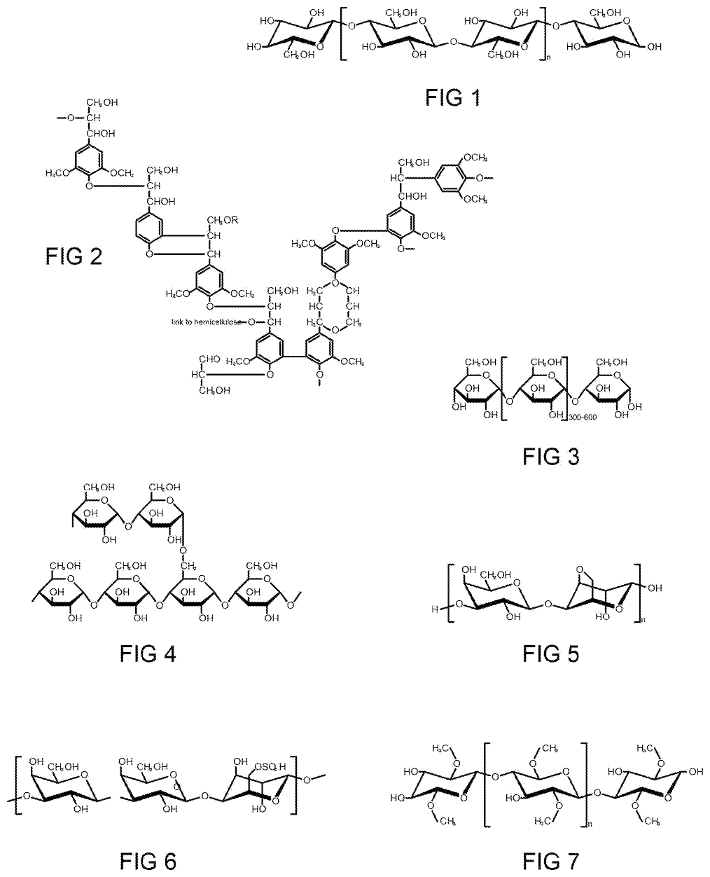

In various embodiments, the fibers are wood-based fibers. In some particular embodiments, the fibers are wood dust or wood chips with dimensions ranging from 0.1 mm to 20 mm. Wood consists of cellulose fibers (FIG. 1) and lignin (FIG. 2). In some embodiments of the invention, the fibers are paper pulp. In some embodiments of the invention, the fibers are cellulose (FIG. 1). In some embodiments of the invention, the fibers are products of non-woody plants.

In various embodiments, all or part of the binder is starch-based, consisting of amylose (FIG. 3) and/or amylopectic (FIG. 4). In some embodiments, all or part of the binder is agar, consisting of agarose (FIG. 5) and/or agaropectin (FIG. 6). In some embodiments, the binder is a mix of starch and agar. In some embodiments, the binder is methylcellulose (FIG. 7). In some embodiments, the binder is modified starch.

The present invention contains a solvent. In some embodiments of the invention, the solvent is water.

In various embodiments, the invention contains an acid. In one embodiment, the acid is vinegar.

In various embodiments, the material composition contains additives to slow the speed of the drying process. This can be used when the material is deposited at a large width in order to prevent a drying of the outer surface that can trap moisture on the inside of the 3D-printed object. In various embodiments, this drying agent is a salt. In some specific embodiments of the invention, the drying agent is an organic salt.

In various embodiments, the material composition contains preservative additives to prevent decomposition, microbial growth or undesirable chemical changes.

In one embodiment, the material consists of, by weight, 100 parts pine chips with average dimensions ca. 20 mm×2 mm×0.1 mm (plant fiber), 740 parts water (solvent), 20 parts methyl-cellulose (binder), 5 parts sodium caseinate (drying agent), 10 parts calcium propionate (preservative).

In another embodiment, the material consists of, by weight, 100 parts pine chips with average dimensions ca. 20 mm×2 mm×0.1 mm (plant fiber), 740 parts water (solvent), 150 parts vinegar with 5% acidity (acid), 225 parts corn starch (polymer), 10 parts agar (polymer), 5 parts sodium caseinate (drying agent), 10 parts calcium propionate (preservative).

In another embodiment, the material is prepared by first soaking the plant fiber in some of the solvent, depending on the size of the fiber possibly 240 parts of the above composition. The remaining solvent is mixed with the acid, starch, agar and additives. This mixture is gelatinized. The plant fiber is added to the mixture. The mixture is stored in a closed container without access to air for one week before usage.

In another embodiment, the material consists of, by weight, 100 parts paper pulp (plant fiber), 740 parts water (solvent), 20 parts methylcellulose (binder). This specific embodiment is designed for extrusion beads of 1-5 mm diameter, where a trapping of moisture is unlikely as the extrusion bead is thin, and a decomposition is unlikely as the drying time is not extended by the drying agent.

What is claimed is:

1. A biodegradable material composition for three-dimensional printing through an extrusion mechanism, comprising:
(A) 100 parts by weight plant fibers with dimensions of 0.001 mm-20 mm,
(B) 505-775 parts of a binder, consisting of 5-25 parts of methylcellulose dissolved in 500-750 parts water,
(C) 0-10 parts of an organic salt,
(D) 0-20 parts of a preservative,
whereby said binder ensures the delivery of the material composition through the extrusion mechanism by preventing a clogging of the extrusion mechanism by said plant fibers while connecting the plant fibers after drying.

2. The composition according to claim 1, whereby the binder (B) instead is a mixture of 500-750 parts water, 150-300 parts starch, 0-300 parts vinegar, and 0-20 parts agar, with said mixture gelatinized.
